(19) United States
(12) Patent Application Publication
(10) Pub. No.: US 2002/0144144 A1
(43) Pub. Date: Oct. 3, 2002

(54) Method and system for common control of virtual private network devices

(76) Inventors: Jeffrey Weiss, McKinney, TX (US); Christopher H. Bradley, The Colony, TX (US)

Correspondence Address: Raymond B. Churchill, Jr., Gottlieb, Rackman & Reisman, P.C., 270 Madison Avenue, New York, NY, 10016-0601, US

(21) Appl. No.: 09/818,456

(22) Filed: Mar. 27, 2001

(51) Int. Cl. H04L 9/00

(52) U.S. Cl. 713/201; 713/150

(57) ABSTRACT

A method and system for common control of virtual private network devices. Common control is achieved by configuring one or more virtual private network devices, connected to both an open network and private local area networks, to authenticate clients through a centralized database or directory. The database or directory contains network access information or access policy for use by the virtual private network device(s) to control secure transactions over the open network between clients and the local area networks. The method and system may be used for sharing virtual private network devices between multiple private local area networks to allow various entities with private networks to employ the benefits of working over an open network such as the Internet, while simultaneously avoiding the high cost of acquiring and maintaining their own virtual private network devices.

### FIELD OF THE INVENTION

This invention relates to methods and systems for secure communication between remote clients and private networks over open networks. More specifically, the invention involves a method and system for centralized control of virtual private networking devices to secure communications between remote clients and selected private networks.

### BACKGROUND OF THE INVENTION

A VPN (virtual private network) secures the transfer of data between a location on a private network or LAN (local area network) and one or more remote locations through an open network such as a WAN (wide area network) or the Internet. An open network typically connects multiple local area networks through one or more communications systems that may include conventional public telephone lines, leased lines (wire and optic) and wireless communications such as by satellite transmission. Generally, unintended recipients may access data transmitted over such an open network. However, through encryption and encapsulation technology, virtual private networking is designed to protect the information transmitted so that only the intended recipients may decipher it.

Devices capable of establishing a virtual private network are well known. For example, the patents to Chen, et al. (U.S. Pat. No. 6,158,011), Paulsen, et al. (U.S. Pat. No. 6,055,575), and Gilbrech (U.S. Pat. No. 6,173,399) show methods for virtual private networking using a VPN device. In general, the VPN device acts as a gateway providing encryption, encapsulation and authentication services for a VPN connection to a remote client or another VPN device. A typical VPN session involving a remote client begins with a client connecting to the VPN device. Upon connection, a secure tunnel between the client and VPN device is established such that all data transmissions between the VPN device and the client are encrypted and encapsulated. The VPN device authenticates the client, typically by username and password, using a lookup table or other memory structure located at the device. After authentication, the VPN device may apply LAN access policies or filters assigned to the specific client or user based upon the group to which the user belongs. This allows the VPN device to control the nature of the client's access to a private LAN connected by the device while maintaining the secure tunnel. While the tunnel is in use, data transmitted from the VPN client through the tunnel is decrypted by the VPN device and forwarded over the private LAN.

While these devices are effective, they are complex and costly. As a VPN device itself contains LAN access information such as user and group identities, management of one or more VPN devices is complex since the data entries in each VPN must be coordinated and kept up to date with respect to ever evolving personnel rosters and technology infrastructure changes. Moreover, VPN devices are not economically attractive for the majority of smaller private computing networks whose users wish to engage in secure transactions over an open network. Thus, many businesses with LANs are unable to expand their technology infrastructures to leverage the conveniences of an open network such as the global Internet while maintaining information security. Additionally, since a VPN device will allow a large minimum number of connections, in many cases the capacity of a VPN is not fully utilized.

### BRIEF DESCRIPTION OF THE INVENTION

An objective of the present invention is to simplify the management of multiple VPN devices by centralizing control and maintenance of LAN access data.

A further objective of the present invention is to provide a method for sharing the use of one or more VPN devices among multiple customers or multiple private local area networks.

A still further objective of the present invention is to accomplish these goals while using presently available VPN devices without making substantial modifications thereto.

Additional objectives will be apparent from the following description of the invention.

In its broadest aspect, the present invention involves a system and method for common or centralized control of multiple VPN devices. Generally, the system, which may be managed by a single entity, is implemented by centralizing client credentials and LAN access information including, for example, user identities, customer identities and access policies such as time windows, encryption levels, compression specifics, and other identity filters. The LAN access information for multiple VPN Devices is centralized in a common database server that may be independent from the VPN devices.

To accommodate centralization of the LAN access information, the current invention utilizes a unique authentication procedure. Essentially, rather then performing a search on a locally stored lookup table or database, each VPN device connects through an authentication server to the common remote database.

In one embodiment, a VPN device is pre-configured with connection policies including time windows, identity filters, compression routines and encryption levels, which are organized by group identities. When the common database server returns LAN access information to the VPN device in the form of a group (i.e. company or customer) identification, the VPN device uses the group identity to apply locally stored connection policies that are associated with the identified group. Alternatively, the common database server may maintain LAN access information such as time windows, identity filters and encryption levels that are transferred to a VPN device upon proper authentication of a remote client. In this event, the VPN device applies the transferred connection policies.

With this centralization, the shared use of VPN Devices among multiple private LANs of distinct entities or customers may be achieved. To this end, the common database may be organized to identify users by an additional abstraction such as a company name. With this organization, an authentication search of the common database for a username and password would result in the identification of a company name and then LAN access information would be further identified using the company name.

### BRIEF DESCRIPTION OF THE DRAWINGS

FIG. 1 is a network diagram showing prior art use of VPN devices through an open network.

FIG. 2 is a network diagram showing a simple embodiment of the present invention;

FIG. 3 is a flow chart depicting the authentication steps involved in implementing the common control of VPN devices of the present invention;

FIG. 4 is a network diagram showing a simple sharing of a VPN device by two private LANs.

FIG. 5 is a network diagram showing a multiple building/multiple customer embodiment of the present invention in which a VPN device may be shared by multiple enterprises or LANs;

FIG. 6 is a network diagram showing a similar by extended embodiment of the present invention; and

FIG. 7 is a flow chart including generalized steps for achieving the common control of virtual private networking devices;

### DETAILED DESCRIPTION OF THE INVENTION

The following terms as used throughout this specification have the following meanings:

LAN refers to a local area network. A local area network is a connected group of electronic devices or computers at a single location such as a building or office. A LAN typically utilizes networking devices such as Ethernet and Token Ring circuits. A private LAN generally includes the devices of a single enterprise or customer.

Open Network is a communications network connecting multiple LANs where the Open Network is generally accessible to the public at large. An Open Network generally uses a common information transfer protocol. One such Open Network is the global Internet which uses the TCP/IP protocol.

MPOP refers to a metropolitan point of presence. A metropolitan point of presence is a network location having a bank of connections for dial-up access by one or more independent communications devices or computers or LANs. Alternatively, a MPOP may utilize a bank of direct line access connections such as optical fibers, coaxial cable or an equivalent. A MPOP may also provide a combination of dial-up and direct access methods. Typically, a MPOP is also connected to an Open Network.

An Encrypted Tunnel is a method of encoding and/or encapsulating data packets for transmission over a communications network to an intended recipient for decryption where the transmitted data can generally not be deciphered by unintended recipients. Protocols for generating such tunnels, or encrypted data streams, include, for example, IP Security (Ipsec) and the Point-to-Point Tunneling Protocol (PPTP).

The IPsec standard defines a set of security protocols that authenticate IP connections and add confidentiality and integrity to IP packets. IPsec packets are transparent to applications and the underlying network infrastructure. IPsec supports multiple encryption and authentication protocols so the security policy can dictate levels of data privacy and authentication. An IPsec client from Altiga is available for Windows 95, Windows 98, Windows NT, and Windows 2000.

PPTP is a tunneling protocol supported by Microsoft, Nortel Networks, and other vendors. The PPTP client is available for Windows 95 and is built-in to Windows 98 and Windows NT. PPTP supports multiple authentication schemes: MS-CHAP, CHAP, or PAP. Additionally, the protocol allows for selection of compression, RC4-based encryption, and assignment of DNS and WINS servers to the tunnels.

A VPN Device is a device used to establish secure data streams, such as, for example, Encrypted Tunnels, through an Open Network to other VPN devices or VPN Clients. A VPN Device may also authenticate users and apply or control the connection polices for the data stream using LAN Access Information.

LAN Access Information consists of VPN Device configuration parameters which may include, for example, IP address or other machine address filtering, compression type, encryption type, and time window access limitations, and may be organized by a classification such as, for example, a group identification.

A VPN Client is a remote terminal, electronic device or computer that runs a software application capable of establishing a secure data stream with a VPN Device.

An Authentication Server is a service on an electronic device or computer used to authenticate users or client credentials to control access to various services on a local area network. An example of one such Authentication Server is a RADIUS Server. RADIUS (Remote Authentication Dial-In User Service) is a client/server protocol implemented in software that enables remote access servers to communicate with a central server to authenticate dial-in users and authorize their access to the requested system or service. RADIUS allows a company to maintain user profiles in a central database that all remote servers can share. It provides better security, allowing a company to set up a policy that can be applied at a single administered network point. Having a central service also means that it's easier to track usage for billing and for keeping network statistics. Created by Livingston (now owned by Lucent), RADIUS is a de facto industry standard used by Ascend and other network product companies and is a proposed IETF standard.

A Database Server is a service on an electronic device or computer used to store searchable indexed information and includes, for example, a SQL server. For purposes of this application, a Database Server may also be a directory server such as, for example, a directory server using the Lightweight Directory Access Protocol (LDAP).

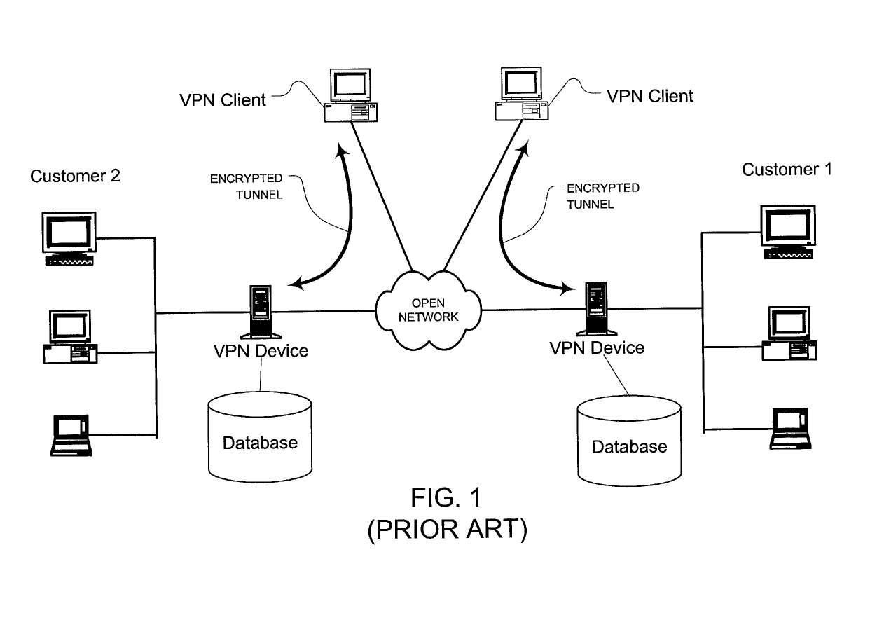

FIG. 1 depicts a typical prior art network utilizing VPN devices. Each VPN Device is used by a single customer or entity to generate secure connections between that customer's remote clients and LAN. Any entity desiring to establish a VPN must go to the expense of acquiring its own VPN devices for its LAN. To this end, each such entity would store LAN Access Information in a database associated with its VPN Device. As additional VPN Devices are added (not shown), LAN Access Information is stored in these devices as well. The maintenance effort associated with keeping all VPN devices configured may be excessive. Furthermore, a single VPN device may have greater capacity than is required for many small entities, giving rise to needless expense.

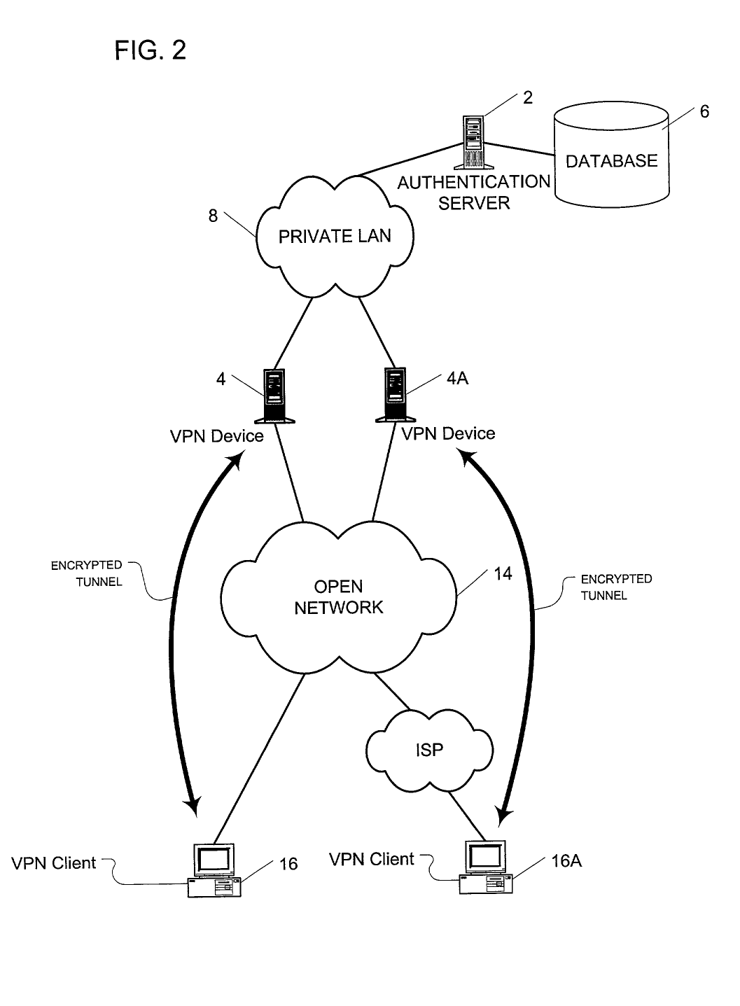

With reference to the most basic embodiment of the invention shown in FIG. 2, a system to carry out the present invention generally involves a VPN device 4 or 4A, an Authentication Server 2, a Database Server 6 and a private LAN 8. The VPN Device 4 or 4A is connected between the private LAN 8 and an Open Network 14. Common control of the VPN Device 4 or 4A is achieved using the common or centralized Database Server 6. Ideally, the Authentication Server 2 is located near or with the Database Server 6 and is separate from the VPN Device 4. However, a VPN Device 4 might be used also as the Authentication Server 2 and common Database Server 6 for other VPN Devices. VPN Client 16 or 16A may connect to the private LAN 8 through VPN Devices 4 or 4A if they are authenticated by the VPN Devices 4 or 4A using Authentication Server 2 and Database Server 6.

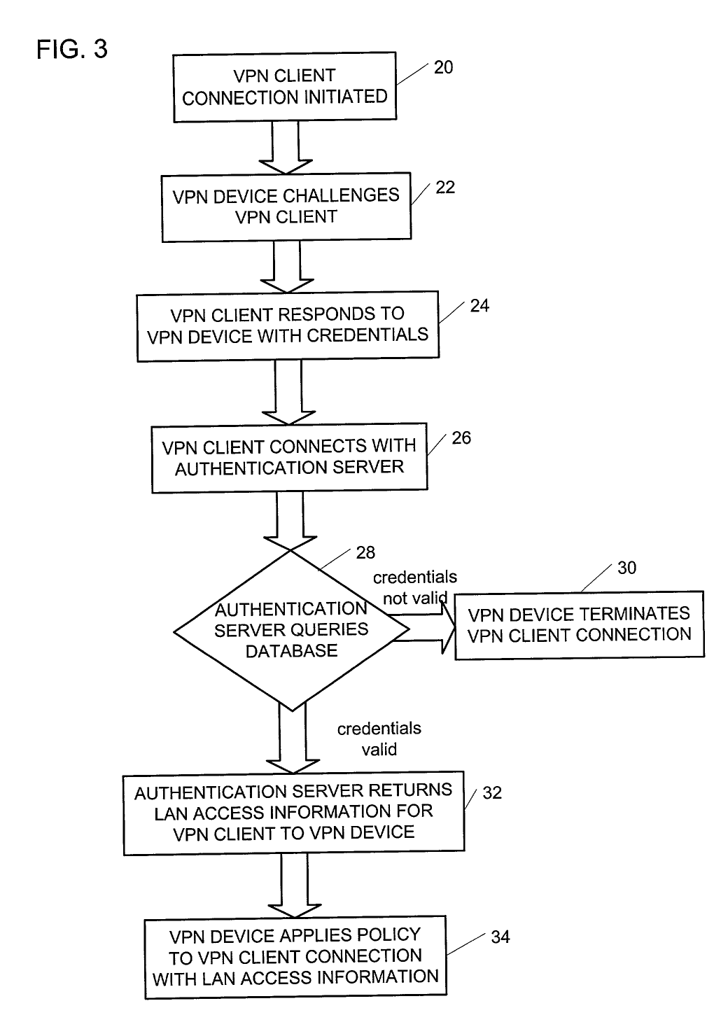

The benefits of this configuration, if not immediately apparent, will become more clear by examining a typical login scenario between a remote VPN Client 16 and Private LAN 8 with reference to FIG. 3. VPN Client 16 establishes a connection with Open Network 14. This connection may be by any available means for connecting to the Open Network such as a wireless, direct or dial-up line, for example, through an Internet Service Provider (ISP). With regard to FIG. 3, in step 20, the VPN Client 16 attempts to access Private LAN 8 at which time an Encrypted Tunnel is established. In step 22, the VPN Device 4 challenges the VPN Client 16 through the Encrypted Tunnel. In response to the challenge, in step 24, VPN Client 16 supplies user or client credentials. In the preferred embodiment, the credentials include a user identification (username) and a password.

With the user or client credentials, in step 26, the VPN Device 4 then connects with the external Authentication Server 2. During this connection, in step 28, the VPN Device 4, through the Authentication Server 2, initiates a search of the Database Server 6 to verify VPN Client's 16 right to access the Private LAN 8. If the verification search of step 28 is unsuccessful, the VPN Device 4 will terminate the Encrypted Tunnel to the VPN Client 16. If the verification search is successful, in step 28, the search will return LAN Access Information to the VPN Device 4.

In one embodiment of the present invention, useful for sharing virtual private network devices between multiple entities or companies, the Authentication Server 2 performs a search of the Database Server using a forwarded username and password. If the search is successful, the Authentication Server 2 accesses a company name that is associated with the VPN Client's credentials. Using the company name, the Authentication Server 2 then retrieves a Group Identification associated with the company name. The Group Identification is returned to the VPN Device 4. In this embodiment, the VPN Device 4 is pre-configured with LAN Access Information. The VPN Device 4 simply applies the LAN Access Information to the Encrypted Tunnel that is associated with the returned Group Identification. Through the use of the additional abstraction which organizes customers by the classification of Company Name instead of only Group Identification, a more efficient use of the VPN Device 4 can be achieved when a greater number of users share any number of the VPN Devices. The abstraction simplifies the maintenance required for associating users with the related LAN Access Information. Additional abstraction classifications may also be used to increase sharing and access options.

In an alternative embodiment, the Authentication Server 2 returns more than just a Group Identification. In this embodiment, the Database Server maintains some or all of the LAN Access Information necessary for the VPN Device. In this event, in step 32, a successful verification search would forward some or all of the LAN Access Information stored. Upon receipt by the VPN Device, the LAN Access Information would be applied to the current Encrypted Tunnel. Through this process, the maintenance of multiple VPN Devices for multiple private LANs is minimized, since only a single database would need to be modified when changes are necessary.

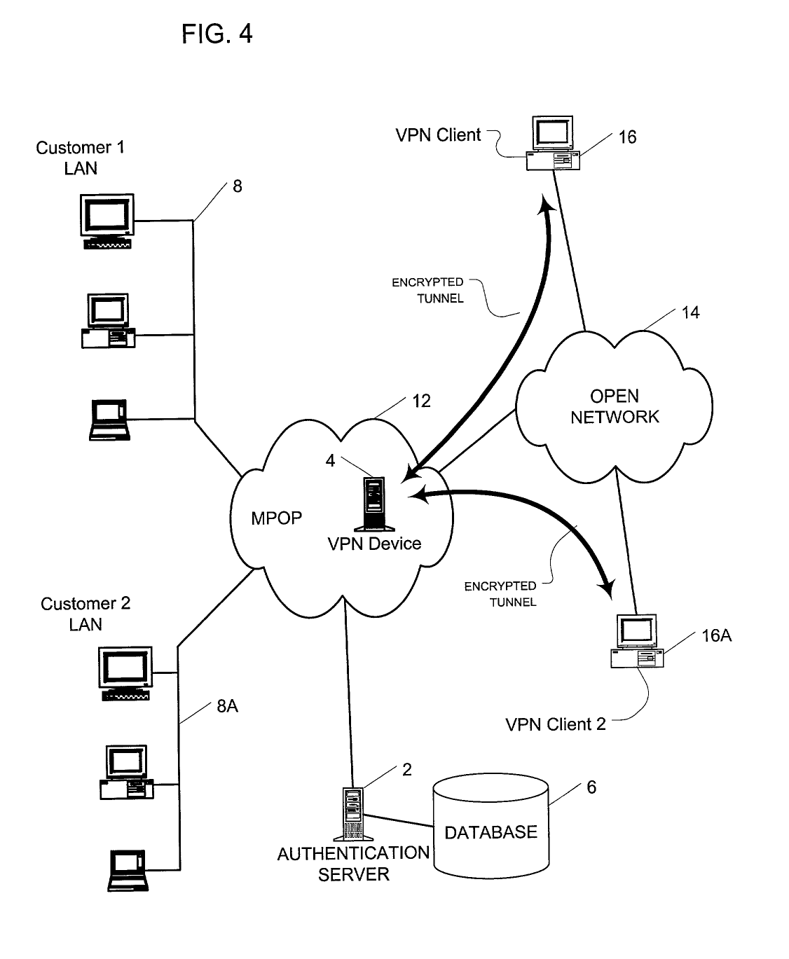

A system for the sharing of a VPN Device by two customers or enterprises is depicted in FIG. 4. The system generally involves VPN device 4, Authentication Server 2, Database Server 6 and two or more private LANs 8, 8A run by distinct customers or entities. The VPN Device 4 is locally connected at an MPOP 12, between the dataflow of private LANs 8, 8A and an Open Network 14. The Authentication Server 2 may also be located at the MPOP 12 or at some other location accessible by the VPN Device 4 over a communication or network connection. Customer or private LANs 8, 8A will generally be on a site separate from the MPOP 12 but may also share a location with the MPOP 12. While FIG. 4 portrays the private LANs 8, 8A, of only two customers, it is understood that additional private LANs of the same or additional customers may be connected to the MPOP 12. Similarly, depending upon the number of Encrypted Tunnels necessitated by the private LANs 8, 8A, additional VPN devices 4 may be utilized at the MPOP 12.

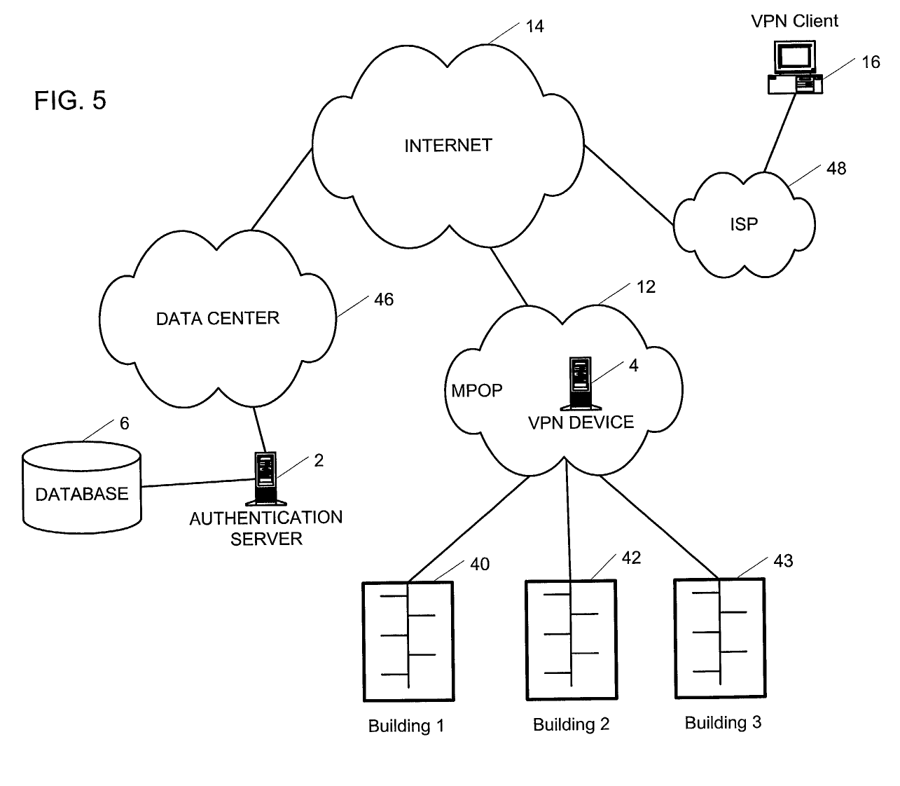

Another embodiment of the present invention is shown in FIG. 5. In that embodiment, a more efficient use of an MPOP 12 is depicted. Referring to FIG. 5, MPOP 12 is networked to Buildings 40, 42, 44 through the VPN Device 4. Each Building 40, 42, 44 may contain one or more private LANs operated by one or more customers or entities. Alternatively, the Buildings 40, 42, 44 may contain a network of a single customer. The Buildings 40, 42, 44 each share one or more VPN Devices 4 through one or more network routers (not shown). LAN Access Information maintained by Database Server 6, is accessible by the VPN Device 4 through Open Network 14 to Authentication Server 2 on a Data Center 46 network, preferably by encrypted transmission such as an Encrypted Tunnel. VPN Client 16, having a user identification and password in Database Server 6, can access a private LAN in one or more of buildings 40, 42, 44 by an Encrypted Tunnel to VPN Device 4 depending upon the LAN Access Information associated with the VPN Client's credentials.

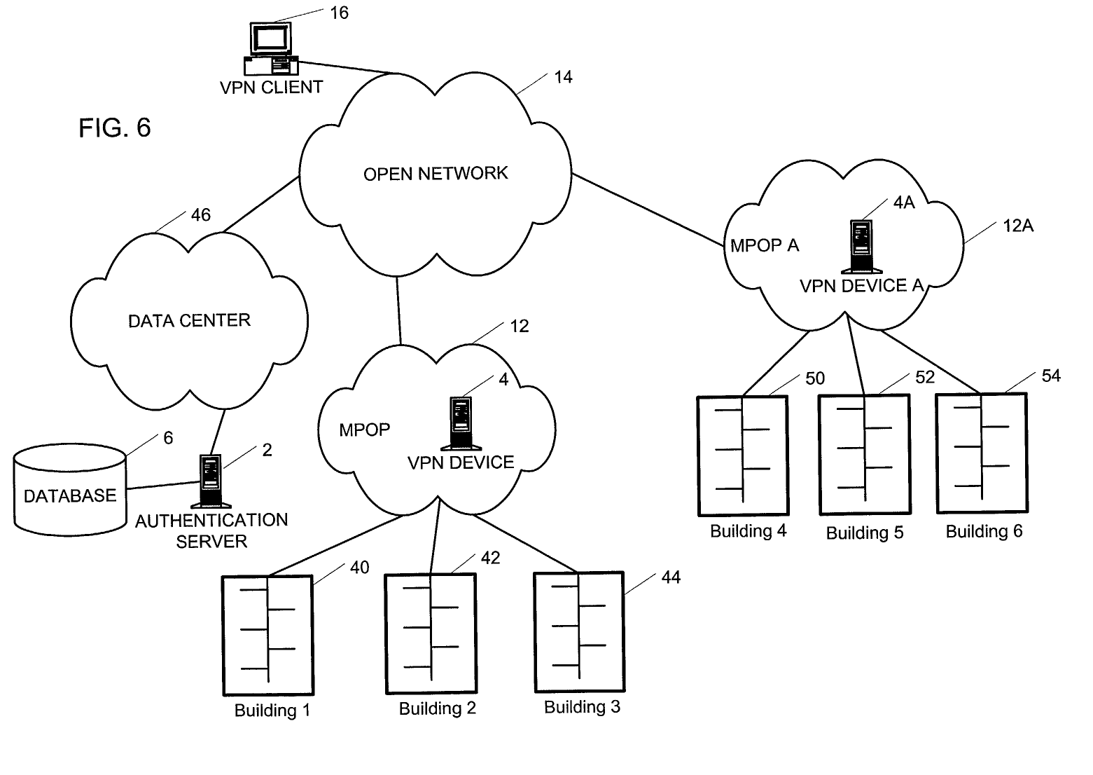

A further extension of the invention is depicted in FIG. 6. Generally, the diagram depicts two MPOPs 12, 12A each with one or more VPN Devices 4, 4A. MPOP 12A is networked through VPN Device 4A with several buildings 50, 52, 54 having one or more private LANs of several customers. As in FIG. 5, MPOP 12 is networked through VPN Device 4 to buildings 40, 42, 44. Some or all of the LAN Access Information for each building 40, 42, 44, 50, 52, 55 is stored in the Database Server 6. Depending upon whether VPN Client 16 has credentials stored in the Database Server 6, VPN Client 16 may securely connect with one or more private LANs in buildings 40, 42, 44, 50, 52, 55 depending upon the LAN Access Information associated with the user or client credentials. Consistent with the principles of the invention, additional buildings and additional MPOPs may also be added as new locations and private LANs are acquired.

In the preferred embodiment of the invention, the Authentication Server 2 is a RADIUS Server. Several RADIUS Servers are available on the market, for example, the Steel-Belted Radius/Service from Funk Software, Inc., 222 Third Street, Cambridge, MA 02142. Alternatively, an open source Radius Server is freely available at www.FreeRADIUS.org or www.miquels.cistron.nl/radius/.

The preferred Database Server 6 is an LDAP directory organized to include at least usernames, passwords, company names, group identifications and other management information as necessary. Access to the LDAP directory may be made using a standard application programming interface (API). As depicted in the FIGS. 2, 4, 5 and 6, it is important for the present invention to maintain a common or centralized data store. This centralization permits ease of maintenance when multiple customers, each with unique LAN configurations and requirements, share one or more common VPN Devices 4. To accommodate the above-identified authentication process with a RADIUS Server and the LDAP directory, the RADIUS Server authentication procedure is modified to perform a bind to recover a company name using the provided username and password. An additional bind is then performed to recover the LAN Access Information such as the Group Identification. An individual skilled in the field will readily recognize the steps needed for modification to accomplish the procedure.

In addition, the VPN Device 4 preferably consists of a VPN Concentrator Model C30 manufactured by Altiga Networks (presently CISCO 3000 Series Concentrators). This device may be used to support up to 5000 Encrypted Tunnels and may be used with additional VPN Devices in parallel for additional tunnels and may be configured to authenticate through an Authentication Server. The VPN Concentrator Model C30 may be installed in parallel with a firewall. The VPN Device's private port is configured to connect with the private LANs 8, 10. The VPN Device's public interface is configured to connect with the Open Network 14. However, other alternative VPN Devices 4 may also be configured for use in the present system.

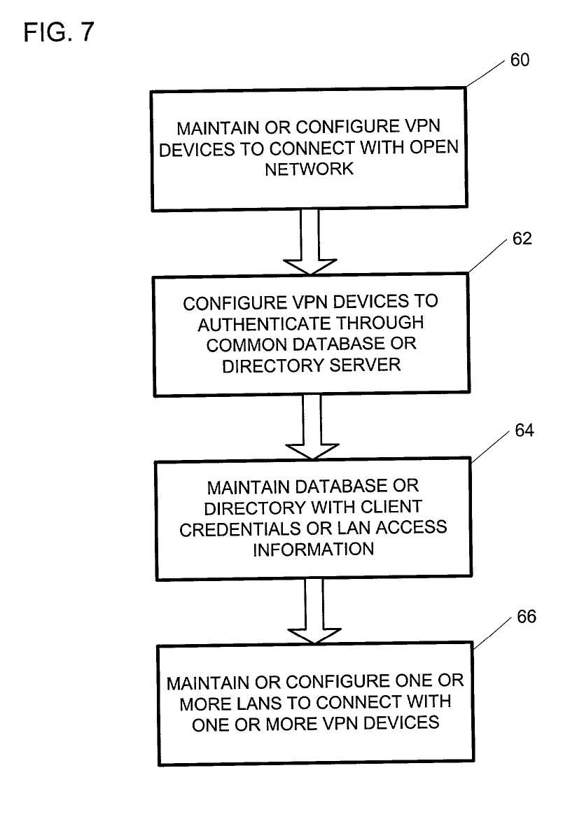

A summarization of the steps for achieving the goals of the above systems is described in FIG. 7. In step 60, the VPN Devices are maintained or configured to connect with an open network. In step 62, the VPN Devices are configured to authenticate through use of a centralized or common Database Server. In step 64, the Database Server is maintained to include client credentials and LAN Access Information for the VPN Devices. Finally, in step 66, the VPN Devices are maintained or configured to connect with one or more private LANs.

By applying the principles of the present invention as disclosed, it is apparent that a management entity may provide the use of one or more VPN Devices on a shared basis to a multitude of customers having private LANs where the customers are interested in virtual private networking. The management entity would arrange for the connection of the private LANs to a MPOP where the management entity would locate the VPN Devices. The management entity would also maintain user or client credentials and LAN Access Information for access to each private LAN as required by each VPN Device in a centralized location. The management entity may then charge customers for the virtual private network service. Preferably, charges would be based upon a monthly use rate depending on the number of connections needed by each customer. The charge to each customer, in general, should be less expensive than each customer's cost of purchasing and managing the technology on their own. The management entity would benefit from the ease of maintenance associated with the data centralization and the customers would benefit from having use of necessary, beneficial and complex technology without high purchase cost and maintenance obligations.

Although the invention has been described with reference to various embodiments, it is to be understood that these embodiments are merely illustrative of an application of the principles of the invention. Numerous modifications may be made to the illustrative embodiments of the invention and other arrangements may be devised without departing from the spirit and scope of the invention.

1. A system for allowing common control of at least two virtual private network devices comprising:
at least two virtual private network devices each adapted to establish one or more encrypted data streams over an open network between a group of clients and a respective local area network; and
an authentication server and database that are accessed by said virtual private network devices;
wherein said authentication server verifies client credentials for said local area network thereby allowing maintenance of only a single authentication server and database for both of said virtual private network devices.

2. The system of claim 1 wherein said database stores network access information for said local area network for use by said virtual private network devices.

3. The system of claim 2 wherein said network access information includes a group identification.

4. The system of claim 3 wherein said database stores user identifications, passwords and customer identifications.

5. The system of claim 2 wherein said network access information includes address filters.

6. The system of claim 2 wherein said network access information includes device address filters.

7. The system of claim 2 wherein said network access information includes compression types.

8. The system of claim 2 wherein said network access information includes time access constraints.

9. The system of claim 2 wherein said network access information includes encryption types.

10. The system of claim 2 wherein said database is a directory service.

11. The system of claim 10 wherein said directory service is accessible via LDAP.

12. The system of claim 2 wherein said database is remote from said authentication server.

13. The system of claim 12 wherein said database is accessed over an open network.

14. The system of claim 12 wherein said database is accessed over a local area network.

15. A system for sharing a virtual private network device comprising:
a virtual private network device capable of establishing one or more encrypted data streams over an open network between a group of clients and a first private local area network, and between a second group of clients and a second private local area network; and
an authentication server and database that are shared by said first and second private local area networks;
wherein said authentication server verifies client credentials stored in said database to control access by respective clients to both of said networks through said virtual private network device;

16. The system of claim 15 wherein said database stores local area network access information for said first and second private local area networks for use by said virtual private network device.

17. The system of claim 16 wherein said network access information includes a group identification.

18. The system of claim 16 wherein said network access information includes address filters.

19. The system of claim 16 wherein said network access information includes device address filters.

20. The system of claim 16 wherein said network access information includes compression types.

21. The system of claim 16 wherein said network access information includes time access constraints.

22. The system of claim 16 wherein said network access information includes encryption types.

23. The system of claim 17 wherein said database server stores user identifications, passwords and customer identifications.

24. The system of claim 16 wherein said database server is a directory service.

25. The system of claim 24 wherein said directory service is accessible via LDAP.

26. The system of claim 16 wherein said database is remote from said authentication server.

27. The system of claim 26 wherein said remote location is accessed over an open network.

28. The system of claim 26 wherein said remote location is accessed over a local area network.

29. A method for allowing common control of at least two private networking devices comprising:
configuring at least two virtual private network devices to connect to at least one local area network and an open network;
configuring said virtual private network devices to authenticate clients through use of a common database; and
maintaining said common database with client credentials for access to said at least one local area network through said open network using said virtual private network devices.

30. The method of claim 29 further comprising maintaining said common database with access information for use by said virtual private network devices.

31. The method of claim 30 wherein said access information includes a group identification.

32. The method of claim 30 wherein said access information includes address filters.

33. The method of claim 30 wherein said access information includes device address filters.

34. The method of claim 30 wherein said access information includes compression types.

35. The method of claim 30 wherein said access information includes time access constraints.

36. The method of claim 30 wherein said access information includes encryption types.

37. The method of claim 31 wherein said database stores user identifications, passwords and customer identifications.

38. The method of claim 29 wherein said database server is a directory service.

39. The method of claim 38 wherein said directory service is accessible via LDAP.

40. A method for sharing private network devices among private local area networks comprising:
configuring at least one virtual private network device to connect to a first private area network, a second private local area network and an open network;
configuring said virtual private network device to authenticate clients through use of a common database; and
maintaining said common database with credentials for clients of said first and second private local area networks.

41. The method of claim 40 further comprising maintaining said common database with access information for use by said virtual private network device.

42. The method of claim 41 wherein said access information includes a group identification.

43. The method of claim 41 wherein said access information includes address filters.

44. The method of claim 41 wherein said access information includes device address filters.

45. The method of claim 41 wherein said access information includes compression types.

46. The method of claim 41 wherein said access information includes time access constraints.

47. The method of claim 41 wherein said access information includes encryption types.

48. The method of claim 42 wherein said database stores user identifications, passwords and customer identifications.

49. The method of claim 40 wherein said database is a directory service.

50. The system of claim 49 wherein said directory service is accessible via LDAP.

51. A method for sharing virtual private network devices by multiple private local area networks comprising the steps of:
maintaining at least one virtual private network device connected to a plurality of private local area networks and an open network wherein said virtual private network device is capable of establishing encrypted data streams over an open network with clients of said plurality of private local area networks; and
maintaining client credentials and LAN access information for access to said private local area networks using said virtual private network device in a centralized database server;

52. The method of claim 51 further comprising:
maintaining an authentication server configured to access said database server and return said LAN access information to said virtual private network device.

53. The method of claim 51 or 52 wherein said LAN access information includes a group identification.

54. The method of claim 51 or 52 wherein said LAN access information includes address filters.

55. The method of claim 51 or 52 wherein said LAN access information includes device address filters.

56. The method of claim 51 or 52 wherein said LAN access information includes compression types.

57. The method of claim 51 or 52 wherein said LAN access information includes time access constraints.

58. The method of claim 51 or 52 wherein said LAN access information includes encryption types.

59. The method of claim 51 or 52 wherein said client credentials includes user identifications and passwords and said database server stores said client credentials with company names.

60. The method of claim 59 wherein said database server is a directory service.

61. The system of claim 60 wherein said directory service is accessible via LDAP.
